(19) United States
(12) Patent Application Publication
(10) Pub. No.: US 2006/0221299 A1
(43) Pub. Date: Oct. 5, 2006

(54) ANGLE ADJUSTMENT MECHANISM FOR EYEGLASS TEMPLES

(76) Inventor: Ta-Tung Wang-Lee, Tainan City (TW)

Correspondence Address: NIKOLAI & MERSEREAU, P.A., 900 SECOND AVENUE SOUTH, SUITE 820, MINNEAPOLIS, MN, 55402, US

(21) Appl. No.: 10/907,467

(22) Filed: Apr. 1, 2005

(51) Int. Cl. G02C 5/14

(52) U.S. Cl. 351/120

(57) ABSTRACT

Provided is a pair of eyeglass comprising a frame comprising a recess at its either end-piece; a pair of temples each comprising an elongate slot at a front end, an opening on an inner surface in communication with the slot, and a plurality of parallel fins on a blind end of the slot; and a pair of flexible angle adjustment assemblies each comprising a forward projection fitted in the recess and releasably secured thereto, a rear extension having a tab at its end, and an intermediate protrusion at an inner side of the extension. The extension is inserted into the slot with the tab slidably secured to a gap between two adjacent fins and the protrusion firmly projected from the opening. Pivoting the temple about the end-piece will interfit the tab and a gap between a pair of adjacent fins.

### BACKGROUND OF THE INVENTION

1. Field of Invention

The present invention relates to devices for an eyeglass temple adjustment and more particularly to an improved angle adjustment mechanism for eyeglass temples.

2. Related Art

There have been numerous suggestions in prior patents for adjusting an angle of either eyeglass temple with respect to frame. For example, U.S. Pat. No. 6,618,901, entitled “Eyeglass Temples With Angle Adjustment Arrangements” is characterized in that the arrangement comprises an end-piece of frame including a recess and an opening; a connection mechanism received in the recess and including first and second circularly shaped bifurcated ends and a first series of serrations on an inner wall of first circularly shaped bifurcated end; and a fastening mechanism received in the opening and including a second series of serrations formed on an inner shank; and a temple secured to the connection mechanism wherein a ridge of second series of serrations is interfitted into a space between adjacent ones of first series of serrations for pivotably securing connection and fastening mechanisms together, thereby allowing the temple to be pivoted with respect to the end-piece in an operating state.

While the patent can achieve its intended purpose, continuing improvements in the exploitation of angle adjustment mechanisms for eyeglass temples are constantly being sought in order to contribute significantly to the advancement of the art.

### SUMMARY OF THE INVENTION

It is therefore an object of the present invention to provide a pair of eyeglass comprising a frame comprising a recess at its either end-piece; a pair of temples each comprising an elongate slot at a front end, an opening on an inner surface in communication with the slot, and a plurality of parallel fins on a blind end of the slot; and a pair of flexible angle adjustment assemblies each comprising a forward projection fitted in the recess and releasably secured thereto, a rear extension having a tab at its end, and an intermediate protrusion at an inner side of the extension wherein the extension is inserted into the slot with the tab slidably secured to a gap between a pair of adjacent fins and the protrusion firmly projected from the opening; whereby pivoting the temple about the end-piece will interfit the tab and a gap between two adjacent fins.

The above and other objects, features and advantages of the present invention will become apparent from the following detailed description taken with the accompanying drawings.

### BRIEF DESCRIPTION OF THE DRAWINGS

FIG. 1 is an exploded view of a preferred embodiment of an angle adjustment mechanism according to the invention mounted in a joining portion of eyeglass frame and eyeglass temple;

FIG. 2 is a sectional view of the assembled mechanism;

FIG. 3 is a schematic side view of FIG. 2; and

FIG. 4 is a view similar to FIG. 3 for illustrating an angle adjustment operation of the mechanism.

### DETAILED DESCRIPTION OF THE INVENTION

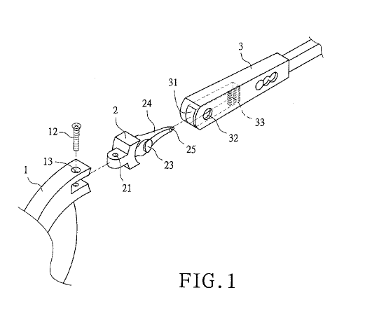

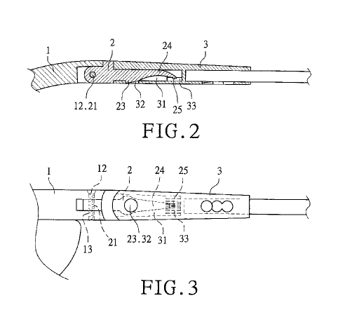

Referring to FIGS. 1 to 3, there is shown an angle adjustment assembly 2 for either temple 3 of a pair of eyeglasses in accordance with a preferred embodiment of the invention. An eyeglass frame 1 comprises at its either end-piece a longitudinal hole 13 through a recess. An eyeglass temple 3 comprises an elongate slot 31 at a front end, an opening 32 on an inner surface in communication with the slot 31, and a series of parallel fins 33 on a blind end of the slot 31 abutted on an inner side of the slot 31. The elongate mechanism 2 comprises a forward projection having a longitudinal hole 21, the projection snugly fitted in the recess at end-piece of the frame 1 with the holes 21 and 13 being aligned such that a screw 12 is adapted to be screwed through the holes 13 and 21 for fastening the mechanism 2 and the frame 1 together. The mechanism 2 further comprises a rear extension 24 slightly bent inward, an intermediate protrusion 23 at the base of the extension 24, and a tab 25 on the inner side of an open end of the extension 24, the protrusion 23 being at the same side of the tab 25. The extension 24 is adapted to insert into the slot 31 until one end of a curved member of the mechanism 2 matingly engaged with a curved front end of the temple 3. Also, the other end of the curved member of the mechanism 2 is matingly engaged with a curved rear end of the end-piece of the frame 1. In the inserted state of the extension 24, the tab 25 is slidably secured to a gap between a pair of adjacent fins 33 and the protrusion 23 is firmly projected from the opening 32. Also, in this inserted state of the extension 24, the mechanism 2 and the temple 3 are fastened together. This completes the assembly of the mechanism 2 in a joining portion of the frame 1 and the temple 3.

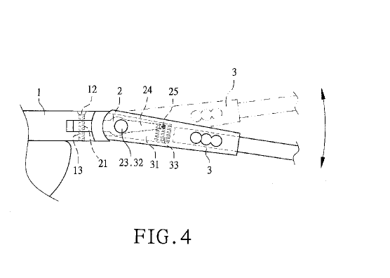

Referring to FIG. 4, a fine angle adjustment operation will be described below. A user may pivot the temple 3 about the end-piece until a comfortable position is reached. This is effected due to the interfitting of the tab 25 and a gap between two adjacent fins 33. Also, the interfitting acts as a stop for the extent of angular travel that the temple 3 can make with respect to end-piece of the frame 1. In addition, the described mechanism 2 acts to retain the temple 3 in the adjusted position. Moreover, the movement of the tab 25 into and out of the gap between any two adjacent fins 33 causes an audible click, designating the proper orientation of each angle adjustment step.

While the invention herein disclosed has been described by means of specific embodiments, numerous modifications and variations could be made thereto by those skilled in the art without departing from the scope and spirit of the invention set forth in the claims.

What is claimed is:

1. An angle adjustment mechanism for eyeglass temples comprising:
a frame comprising a recess at its either end-piece;
a pair of temples each comprising an elongate slot at a front end, an opening on an inner surface in communication with the slot, and a plurality of parallel fins on a blind end of the slot; and
a pair of flexible angle adjustment assemblies each comprising a forward projection fitted in the recess and releasably secured thereto, a rear extension slightly bent inward, and an intermediate protrusion at an inner side of the extension wherein the extension is inserted into the slot.

2. An angle adjustment mechanism for eyeglass temples as claim 1, wherein the rear extension has a tab on the inner side of an open end with the tab slidably secured to a gap between a pair of adjacent fins and the protrusion firmly projected from the opening;
whereby pivoting the temple about the end-piece will interfit the tab and a gap between a pair of adjacent fins.
